(19) United States
(12) Patent Application Publication
(10) Pub. No.: US 2006/0241954 A1
(43) Pub. Date: Oct. 26, 2006

(54) Method and system for adaptive action management for business solutions

(75) Inventors: Jun-Jang Jeng, Armonk, NY (US); Kumar Bhaskaran, Englewood Cliffs, NJ (US); Hung-yang Chang, Scarsdale, NY (US); Kevin Patrick McAuliffe, Cortlandt Manor, NY (US); Quoc-Bao Nguyen, Stramford, CT (US); Yoichi Yoshida, Tokyo (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: International Business Machines Corporation, Armonk, NY (US)

(21) Appl. No.: 11/111,805

(22) Filed: Apr. 22, 2005

(51) Int. Cl. G06Q 99/00

(52) U.S. Cl. 705/1

(57) ABSTRACT

A method (and system) of adaptive action management for business solutions includes detecting a business situation, adaptively deciding an action for a detected business situation using information from a knowledge base, and invoking an action service for implementing the action.

### BACKGROUND OF THE INVENTION

1. Field of the Invention

The present invention relates to a method and system for adaptive action management for business solutions and, more particularly, a method and system which adaptively decides (e.g., and may perform) an action for a detected business situation using information from a knowledge base.

2. Description of the Related Art

Today's business environment demands agility. Businesses on demand to changing customer needs should include flexible systems. Static processes that cannot adapt to changing needs are a liability. Businesses are continuously scrutinizing the effectiveness of their business and information technology (IT) operation opportunities for greater efficiencies.

An On Demand business solution should deliver more timely information, promote proactive recommendations and provide a dynamic interface to enable the underlying systems. More importantly, an On Demand business solution should respond to business situations adaptively. It should allow a business to closely manage business and IT activities across and beyond the enterprise, recognize areas for improvement, quickly implement that optimized system, and bridge business and IT performance.

Unfortunately, conventional business solutions often do not support adaptive features in their action oriented systems. That is, in such solutions, actions are statically defined for a given business exception. The obvious downsides of such conventional systems include (1) it is expensive to change the logic of business actions; (2) it is hard to provide more sophisticated decision making processes in order to select better actions; (3) such solutions are inflexible with respect to selecting a best implementation technology for a certain business action; (4) there is no way of selecting actions based the comparison of the value and cost of performing them; and (5) most implementations do not allow action selection to be improved according to the impact of the performed actions.

### SUMMARY OF THE INVENTION

In view of the foregoing and other exemplary problems, disadvantages, and drawbacks of the aforementioned conventional systems and methods, it is a purpose of the exemplary aspects of the present invention to provide an adaptive action management mechanism in which the business solution can respond to a situation through dynamic action determination, the business can adapt external data sources to invoke actions, and/or the business solutions can select the best implementation for a desired business action.

The present invention includes a method of adaptive action management for business solutions. The method includes detecting a business situation, adaptively deciding an action for a detected business situation using information from a knowledge base, and invoking an action service for implementing the action.

Further, detecting the business situation may include monitoring business solutions and detecting business situations and exceptions according to situation rules. In addition, detecting the business situation may include using a rules engine which correlates business events emitted from a business solution and detects an event pattern to decide whether the business situation occurred. Further, detecting the business situation may include deriving the business situation from a status of a business process with a predefined exceptional state.

Adaptively deciding the action may include, for example, processing incoming business situations, and choosing a business action determination mechanism. Adaptively deciding the action further may include deciding a business action to be taken, mediating necessary data for a decided business action, and selecting a best action service for the decided business action. Adaptively deciding the action may still further include invoking a selected action service, executing an invoked action service, and tracking a result of the executing the invoked action service.

The information on which the adaptive action manager may base a decision, may include at least one of decision rules for choosing action determination services, logics of determining business actions, data mediation logics for parametric data of business actions, bindings and criteria for selecting an action service for a given business action, and a metadata of action services.

The action service (e.g., invoked by the adaptive action manager) may trigger an associated implementation module. The action service may include, for example, at least one of a Java component, a World Wide Web (WWW) service, a workflow, and a rule.

The present invention further includes a system for adaptive action management for business solutions. The system includes a business situation detector which detects a business situation, and an adaptive action manager which adaptively decides an action for a detected business situation, and invokes an action service for implementing the action. The system may further include a knowledge base which is accessible by the adaptive action manager, and stores information, the adaptive action manager deciding the action based on the information. The system may still further include an event processor which may include the business situation detector and at least one of a correlator and a metric caculator.

The adaptive action manager may include, for example, an action mediation manager, a decision-making processor which is consulted by the action mediation manager and returns business actions to the action mediation manager, and an action service manager which receives an invocation of an action service from the action mediation manager and outputs a directive to a target business solution. The action mediation manager may include an action determination service which consults with the decision-making processor, a data mediator which maps data sources to action parameters, an action planner which generates an invocation plan for target actions, and an action service selector which selects the action service.

The action service manager may include an action tracker which tracks an action service invoked by the adaptive action manager, and the adaptive action manager further may include an action exception handler which resolves an exception received from the action tracker. Further, the business solution may include one of a workflow management system (WFMS), enterprise resource planning (ERP), a legacy system, a database, and an external source.

The adaptive action manager may include a meta level control layer including an action determiner determiner (ADD), a performance profile, and a decision tree a control layer including an action determiner (AD), a scheduler, and a planner, and an execution layer including a monitor and an effector, an action effect being fedback from the execution layer to the metal level control layer.

The present invention also includes a programmable storage medium tangibly embodying a program of machine-readable instructions executable by a digital processing apparatus (e.g., a computer-readable medium which stores computer-readable instructions) to perform a method of adaptive action management for business solutions according to the exemplary aspects of the present invention.

The present invention also includes a method for deploying computing infrastructure in which computer-readable code is integrated into a computing system, such that the code and the computing system combine to perform a method of adaptive action management for business solutions according to the exemplary aspects of the present invention.

With its unique and novel features, the present invention provides an adaptive action management mechanism in which the business solution can respond to situation through dynamic action determination, the business can adapt external data sources to invoke actions, and/or the business solutions can select the best implementation for a desired business action.

### BRIEF DESCRIPTION OF THE DRAWINGS

The foregoing and other exemplary purposes, features, aspects and advantages will be better understood from the following detailed description of the exemplary embodiments of the invention with reference to the drawings, in which:

FIG. 1A illustrates a method 100 of adaptive action management for business solutions according to the exemplary aspects of the claimed invention;

FIG. 1B illustrates a system 150 of adaptive action management for business solutions according to the exemplary aspects of the claimed invention;

FIG. 2 illustrates the adaptive action pattern 200 which may be used to implement the system 150 and method 100 according to the exemplary aspects of the present invention;

FIG. 3 illustrates an example of an adaptive action pattern, where the action service (e.g., action determination service) includes a decision-making service 240;

FIG. 4 illustrates the elements (e.g., components) of the adaptive action manager 220 according to one exemplary aspect of the claimed invention;

FIG. 5 illustrates an example of the interaction between the action mediation manager 225 and other components;

FIG. 6 illustrates another example of an adaptive action pattern 600 according to the exemplary aspects of the present invention;

FIG. 7 illustrates how this may be achieved in the present invention. As illustrated in FIG. 7, the adaptive action manager 720 may include a business action determiner 721, physical action determiner 722 and an action service manager 723;

FIG. 8 illustrates a meta-level control structure 800 according to the exemplary aspects of the present invention;

FIG. 9 illustrates an adaptive control lifecycle 900 according to the exemplary aspects of the present invention;

FIGS. 10A-10B illustrate an architecture (e.g., system architecture) 1000 according to an exemplary aspect of the present invention;

FIG. 11 illustrates a business action meta model 1100 according to the exemplary aspects of the present invention;

FIG. 12 provides a detailed illustration of a business action metal model 1100 according to the exemplary aspects of the present invention;

FIGS. 13A-13B illustrate exemplary screenshots 1310, 1320 (e.g., views displayed on a display screen of a graphical user interface (GUI)) which may be included in the exemplary aspects of the present invention;

FIGS. 14A-14B illustrate a top and bottom portion, respectively, of a screenshot 1400 which may be included in the exemplary aspects of the present invention;

FIG. 15 illustrates another screenshot 1500 which may be included in the exemplary aspects of the present invention;

FIG. 16 illustrates a system 1600 which includes a typical hardware configuration which may be used for implementing the inventive system and method for identifying a word correspondence; and

FIG. 17 illustrates a signal-bearing media (e.g., magnetic data storage diskette) 1700, which may be used to store instructions for executing the method according to the exemplary aspects of the present invention.

### DETAILED DESCRIPTION OF THE EXEMPLARY EMBODIMENTS OF THE INVENTION

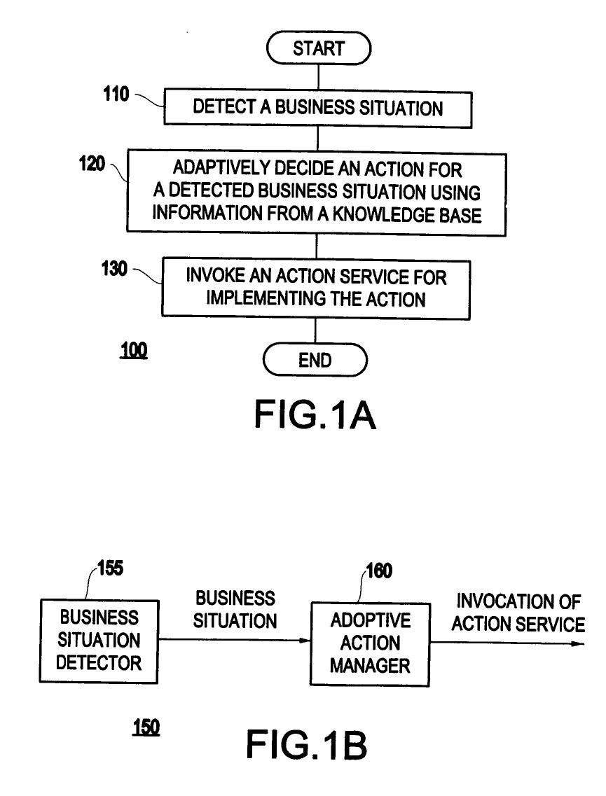

Referring now to the drawings, FIGS. 1A-17 illustrate an exemplary aspect of the present invention.

Specifically, FIG. 1A illustrates a method 100 of adaptive action management for business solutions according to the exemplary aspects of the claimed invention. The method 100 includes detecting (110) a business situation, adaptively deciding (120) an action for a detected business situation using information from a knowledge base, and invoking (130) an action service for implementing the action.

FIG. 1B illustrates a system 150 (e.g., a computer-based system) of adaptive action management for business solutions according to the exemplary aspects of the claimed invention.

The system 150 includes a business situation detector (BSD) 155 which detects a business situation, and an adaptive action manager (AAM) 160 which adaptively decides an action for a detected business situation, and invokes an action service for implementing the action.

An exemplary embodiment of the present invention includes a software framework that provides patterns and building blocks for developing action oriented assets and a mechanism for dynamically managing and invoking them. This framework includes adaptive action patterns as the foundation of the adaptive action management mechanism. Three major service components (e.g., workflow, business process and web service) may be used to realize the framework. The invention further provides an interaction mechanism to enable adaptive action management.

Adaptive Action Patterns

A foundation of the adaptive action management in the system and method of the present invention, is the adaptive action pattern that provides a coherent architectural principle for developing action oriented assets and mechanisms.

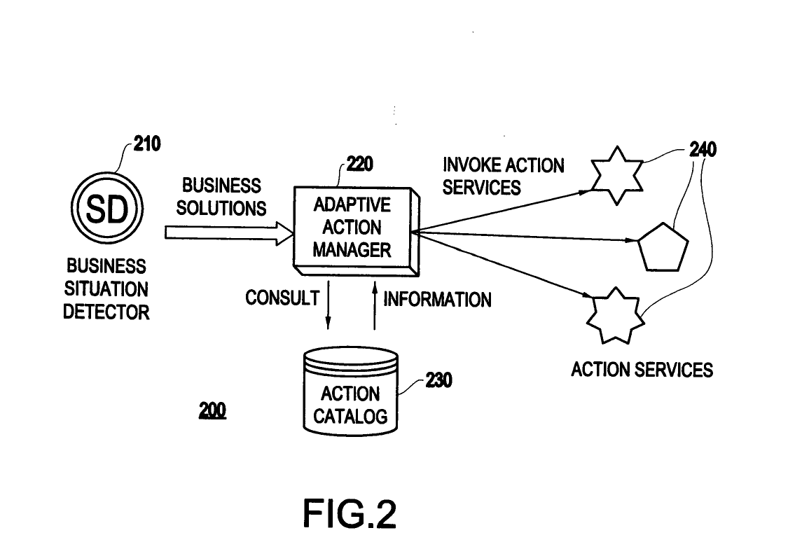

FIG. 2 illustrates the adaptive action pattern 200 which may be used to implement the system 150 and method 100 according to the exemplary aspects of the present invention. As illustrated in FIG. 2, the adaptive action pattern 200 may include elements (e.g., building blocks) which include a business situation detector 210, adaptive action manager 220, action catalog 230, and action services 240. That is, the building blocks of the adaptive action pattern 200 may include:

1. An adaptive action manager (AAM) 220 that is the control center of the operation of triggering actions based on predefined action policies;

2. Action services 240 that are the physical action entities targeted by the AAM to realize the functionality of adaptive action management;

3. A business situation detector (BSD) 210 that monitors business solutions and detects business situations or exceptions, and notifies the AAM; and

4. An action catalog 230 that includes the knowledge base of adaptive action management. The action catalog 230 stores information (e.g., all of the required information) to fulfill the requirements of adaptive action management.

Business Situation Detector (BSD)

The business situation detector 210 may monitor business solutions and detect business situations and exceptions (e.g., according to situation rules). There are many means of detecting business situations. For example, a rules engine can be used to correlate business events emitted from business solutions and detect event patterns to decide whether a situation occurs.

On the other hand, business situations can be derived from the status of a business process with predefined exceptional state. Whenever such a state is reached, a business situation will be generated and sent to adaptive action manager.

Adaptive Action Manager (AAM)

The adaptive action manager (AAM) 220 may receive detected business situations from the business situation detector, decide what actions to be taken, and invoke target action services. This building block along with event catalog may constitute an important (e.g., core) concept of the present invention.

Important functions (e.g., the main functions) of this building block may include: processing incoming detected business situations, choosing a business action determination mechanism, deciding the business actions to be taken, mediating necessary data for decided business actions, selecting an action service (e.g., the “best” or “optimum” action service) for the decided business actions, invoking selected action services, and tracking the execution results of invoked action services.

Action Catalog

The action catalog 230 may store action-related knowledge, process queries from the adaptive action manager, and return necessary information. Simply put, the action catalog may include the knowledge base which supports the operations performed by the adaptive action manager 220.

The action catalog 230 may include data model and well-versed query interfaces (e.g., (e.g., necessary data model and well-versed query interfaces). The information stored in the action catalog may include, for example: (1) the decision rules for choosing action determination services; (2) the logics of determining business actions; (3) the data mediation logics for parametric data of business actions; (4) the bindings and criteria of selecting an action service for a given business action; and (5) the metadata of action services.

Such information may be returned to the adaptive action manager when the action catalog is consulted by the adaptive action manager.

Action Services

Action services 240 may receive invocation messages from the adaptive action manager and trigger an associated implementation module (e.g., a plurality of implementation modules). Action services might come of many forms. For example, action services can include Java components, Web services, workflows, rules engines and so on. The choice of an action service depends on the user requirements and available technologies. Regardless of the underlying implementation, an action service may provide invocation service application programming interfaces (APIs) to the adaptive action manager. The invocation service APIs may include different forms based on the functionality provided by the action service. Examples include email, notification, workflow, business process and so on.

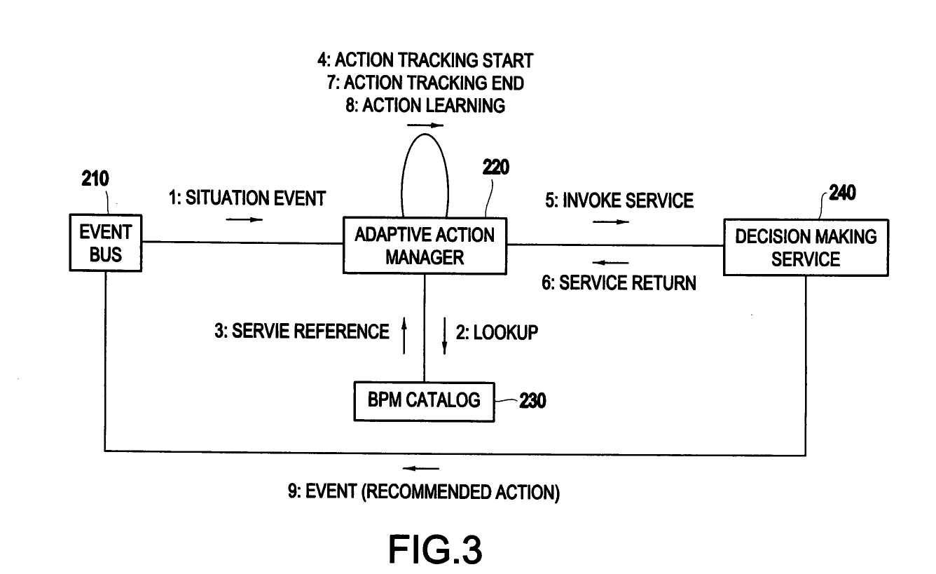

FIG. 3 illustrates an example of an adaptive action pattern, where the action service (e.g., action determination service) includes a decision-making service 240. The decision-making service 240 (e.g., action service) can include, for example, a business process execution language (BPEL) to realize a collaborative decision making process instance which may involve human decision makers (or software agents) to provide recommended actions that will be published as an action event and will be caught by the adaptive action manager.

Specifically, in the exemplary embodiment of FIG. 3, the event bus 210 (e.g., business situation detector) sends a situation event to the adaptive action manager 220. The business performance manager (BPM) catalog 230 (e.g., action catalog) may receive a lookup request from the AAM 220, and return a service reference to the AAM 220. The AAM 220 may receive the service reference, begin action tracking, and send an invocation of action service to the decision-making service 240.

The decision-making service 240 may send a service return to the AAM 220 which may begin an action learning. In addition, the decision-making service may send the event (e.g., recommended action) to the event bus 210.

Adaptive Action Manager Components

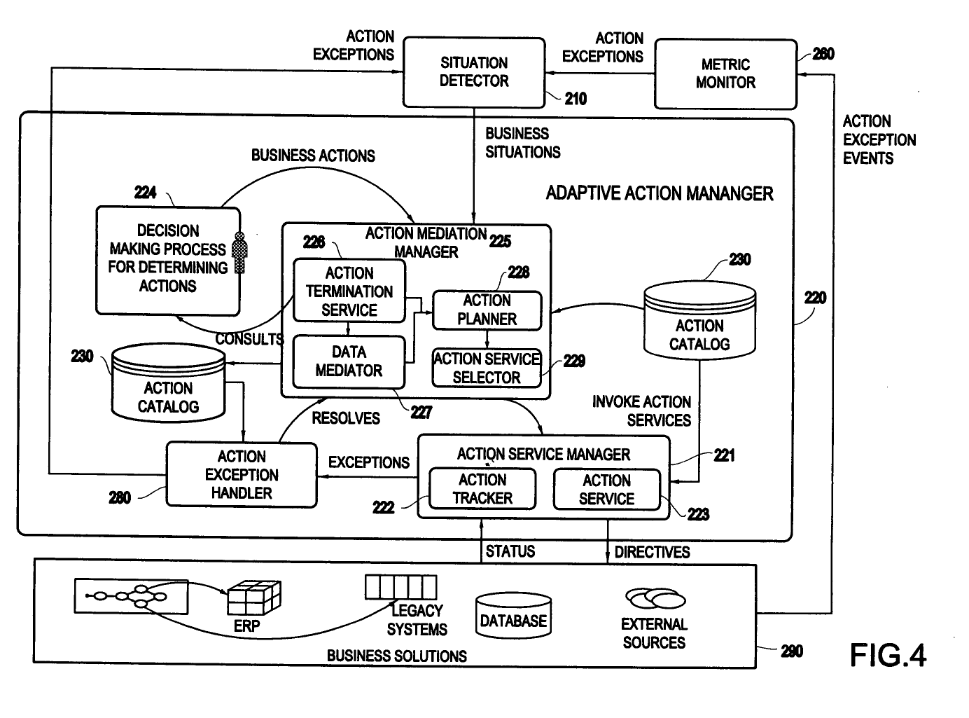

FIG. 4 illustrates the elements (e.g., components) of the adaptive action manager 220 according to one exemplary aspect of the claimed invention. As illustrated in FIG. 4, the elements (e.g., important components) of the AAM 220 may include an action catalog 230 that realizes the functionality of the building block of action catalog 230 as described above, and an action mediation manager 225 that manages the lifecycle of the components (e.g., actions related to the adaptive action manager (AAM) 220) which are described hereinbelow.

Namely, the business situation detector 210 detects business situations and sends them to the adaptive action manager 220. An action determination service 226 may decide what business actions to be taken for a given situation. Note that the action determination service 226 can include many different forms, including, for example, Java components, a rules engine, and a decision-making process (e.g., a decision making processor 224).

Further, the data mediator 227 that may be used to map data sources (e.g., including the data carried by the situation) to action parameters. Actions in different domains may require different kinds of data mediators. An action planner 228 may take decided actions and come up with an invocation plan for target actions. The action planner may also be able to schedule action invocations.

An action service selector 229 may be called to select “physical” action services to be invoked by adaptive action manager 220. An action service invocation may be rendered to the action service manager 221.

The selected action service 222 may issue management directives to target business solutions 290 which may include, for example, a workflow management system (WFMS), enterprise resource planning (ERP), legacy systems, a database, and an external source. That is, the management directives may be sent to the business solutions 290. Execution status may be broadcast to subscribed clients, and an action exception can be published to event bus (e.g., to the situation detector 210 via a metric monitor 260);

An action tracker 223 may catch an action status and, if an exception occurs, send the exception to the exception handler 280. An action exception is sent from the action tracker 222 to the action exception handler 280. The exception handler 280 may try to resolve the exception locally. If the exception handler 280 fails in its attempt to resolve the exception, then the exception may be relayed to a situation detector 210 as a business situation, the cycle may restart.

Action Mediation Manager Interaction with other Components

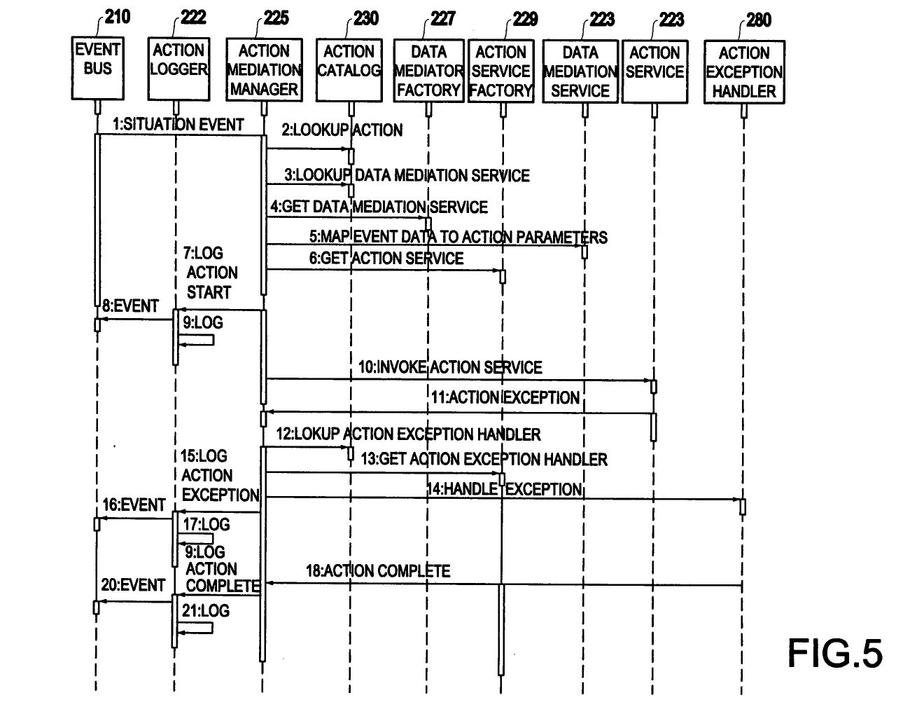

FIG. 5 illustrates an example of the interaction between the action mediation manager 225 and other components. The data mediator 227 (e.g., the data mediator factory) or action service selector 229 (e.g., action service factory) may be used to build an instance of data mediation service 223 (e.g., action service 223) to the action mediation manager 225.

The action logger (e.g., action tracker 222) may be called by either the action mediation manager 225 or the action service 223 to log execution-related messages to the log database (or publish execution-related messages to the event bus).

The present invention has many potential applications. For example, the framework of the adaptive action manager 220 can be leveraged and embedded into business solution monitoring and control system. Most notably, the adaptive action manager 220 can be used to enable control of part of a business performance manager (BPM) system in an On Demand fashion.

The present invention helps to solve the problems of conventional systems and methods. Specifically, the invention may achieve flexible action modeling, enable dynamic action management at runtime, incorporate adaptive decision making process to determine actions, and support action determination, invocation and improvement using meta level control structure.

As noted above, the present invention may accomplish this by using an adaptive action pattern as a foundation. That is, the invention may include flexible action modeling, meta-level control structure, and continuous action improvement.

The present invention may include several embodiments, including a system architecture, models (e.g., data and runtime), and an administrative console.

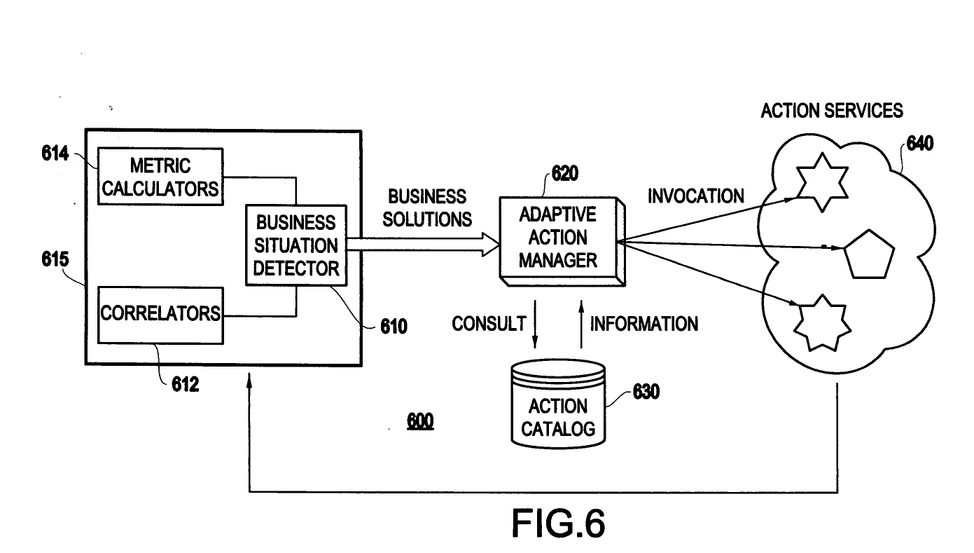

FIG. 6 illustrates another example of an adaptive action pattern 600 according to the exemplary aspects of the present invention. The pattern 600 includes an event processor 615, an adaptive action manager 620, action catalog 630 and action services 640. This pattern 600 is similar to the pattern 200 of FIG. 2 and thus, the discussion above with respect to the pattern 200 is incorporated herein by reference. However, in the pattern 600, the event processor 610 which sends business situations to the adaptive action manager 620 may include a business situation detector 610, a correlator 611, and a metric calculator 612. Further, the action services 640 may include, for example, workflow, business process and web service.

Flexible Action Modeling

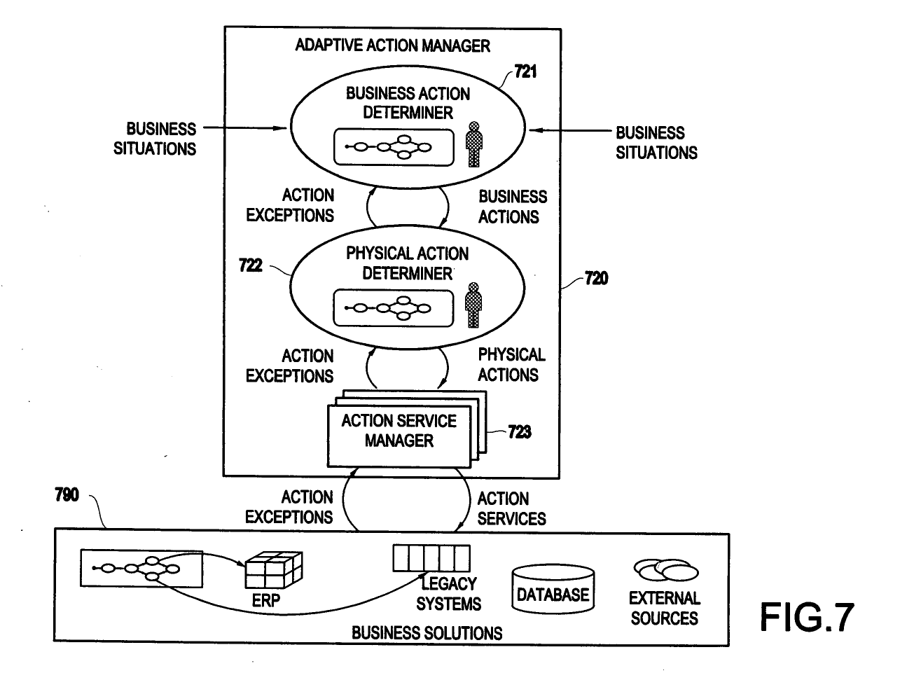

As noted above, a feature of the present invention is that it may provide flexible action modeling. FIG. 7 illustrates how this may be achieved in the present invention. As illustrated in FIG. 7, the adaptive action manager 720 may include a business action determiner 721, physical action determiner 722 and an action service manager 723. The business action determiner may receive business situations (e.g., from the event processor 615), and may send business actions to the physical action determiner 722 which may return action exceptions to the business action determiner 721.

The physical action determiner 722 may also sent physical actions to the action service manager 723 which may return action exceptions to the physical action determiner 722. The action service manager 723 may send action services to the business solutions 790 which may return action exceptions to the action service manager 723.

Specifically, the present invention may include a multi-dimensional separation of concerns. For example, the invention may separate business situations and Business actions, business actions and physical actions (e.g., primitive actions), business action determination and primitive action determination, action determination and parametric value generation, and action determination and action invocation.

The invention may also provide a personalized action modeling framework for multiple user roles.

An important feature of the present invention is that it may also provide a capability of achieving dynamic change management and, therefore, dynamic action management. Thus, for example, the actions of the system may be managed “on the fly”, and in real time, and may be changed without shutting the system down.

The present invention may efficiently perform the roles of several human operators. For example, a business analyst/solution architect may define a business situation, business action, action determination logic, and parametric value mapping logic. A solution developer may develop determination components and data mapping components. A service developer may develop primitive actions, and a solution integrator/system administrator may configure and deploy action manager components.

Meta-Level Control Structure

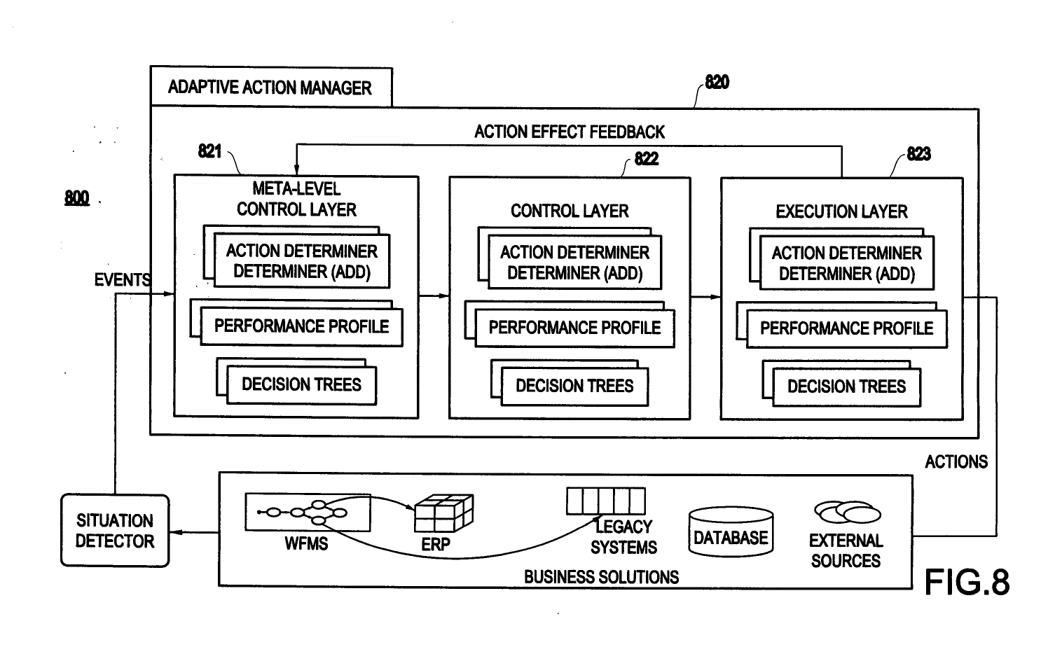

FIG. 8 illustrates a meta-level control structure 800 which may be used to implement the system and method according to the exemplary aspects of the present invention. In the structure 800, the adaptive action manager 820 includes a meta-level control layer 821, a control layer 822 and an execution layer 823.

Generally, the present invention may classify actions into three categories: (1) primitive action; (2) control action; (3) meta-level control action. Primitive actions include executable primitive entities that achieve various high level business actions. Control actions include planning actions that choose the high level business actions, set constraints on how to achieve them and sequence the detailed primitive actions that achieve the business actions.

Meta-level control actions may optimize the action manager's performance by choosing and sequencing control actions. The meta-level control action may be embodied in a decision-making process that involves a sequence of control decisions the consequences of which emerge over time periods of variable and uncertain duration.

In the meta-level control layer 821, when an event arrives at action manager 820, the meta-level control components should decide whether to reason about it; drop the events completely, or to do decision-making about the incoming events. Each of meta-level decisions includes an associated decision tree. Scheduling/planning actions (e.g., for the Control Layer 822) include performance profiles (e.g., cost with respect to scheduling time and revision costs).

Further, the planner/scheduler may be invoked in the control layer 822. The parameters to the scheduler include cost and time. In addition, an uncertainty of primitive actions is possible, and thus more slack time may be realized.

The primitive actions may then be completed. When an action is completed, the meta-control layer checks to see if the real time performance of current task is as expected. If the actual performance deviates from expected performance by more than the available slack time, then a reschedule will be planned.

In the control layer 822, the control functions (e.g., planning and scheduling) are invoked by the meta-level control layer 821 with policy input (e.g. business action structure, goal criteria). When the action manager 820 has to schedule some task but does not have the resources and time to call a complex scheduling algorithm, the generic abstraction of business action structure can be used to provide a reasonable but often non-optimal schedule. The business action structure includes an abstract process with potential schedules and associated performance characteristics.

Otherwise, more accurate scheduling will be performed to find an execution path through a hierarchical action network such that the resultant schedule meets certain design criteria. The control layer components will select a subset of primitive actions from a set of candidate actions. The output will be the best satisfactory schedule as a sequence of primitive actions.

In the execution layer 823 the control layer 822 may invoke the execution components either to execute a single control action prescribed by the meta-level controller, or a sequence of primitive actions determined by the control component.

The execution results may be fed back to meta-level control layer 821 where they are evaluated, and if the execution performance deviates from expected performance, then a reschedule may be satisfied.

Thus, the features of the adaptive action manager (AAM) of the present invention provide an improved functionality. Specifically, the AAM may perform situation analysis which may include, for example, correlation & filtering, a security check, and statistical analysis.

The AAM may also determine business actions which define “what” to be taken in response to Business Situations. Business actions can potentially carry action “policies” on how actions can be invoked. Examples of action policies may include, for example, an action schedule, priority, reward, penalty, retry/timeout, exception handling, performance expectation etc.

The AAM may also determine primitive actions (e.g., physical actions) which define “how” to carry out given business actions. Primitive actions encapsulate invocation logics from their clients. Primitive actions can include many different forms, including, for example, web services, EJB (Enterprise Java Bean), POJO (Plain Old Java Object), MQWF (IBM MQ Workflow Engine), BPEL (Business Process Execution Language) action, email service, notification service, etc.

The AAM may also allow for dynamic registration through the action catalog. The action catalog may serve as the registry of all action related meta data which may include, for example, business actions, primitive actions, determination components, data mapping components etc.

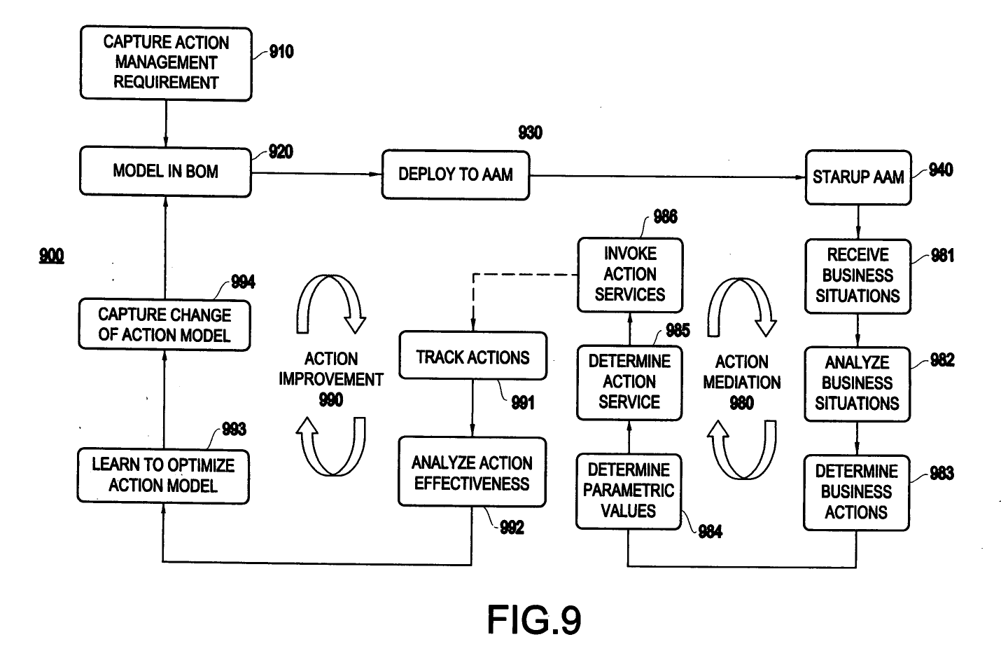

FIG. 9 illustrates an adaptive control lifecycle 900 according to the exemplary aspects of the present invention. As illustrated in FIG. 9, the lifecycle 900 may include capturing an action management requirement (910), modeling into a business object model (BOM) (920), deploying to the AAM (930), and starting up the AAM (940). The adaptive control lifecycle 900 may further include an adaptive action control loop, which may include action mediation 980 (e.g., adaptive action mediation) and action improvement 990 (e.g., continual action improvement).

The action mediation 980 may include, for example, receiving business situations (981), analyzing business situations (982), determining business actions (983), determining parametric values (984), determining action service (985), and invoking an action service (986). The action improvement 990 may include, for example, tracking actions (991), analyzing action effectiveness (992), learning to optimize the action model (993), and capturing changes of the action model (994).

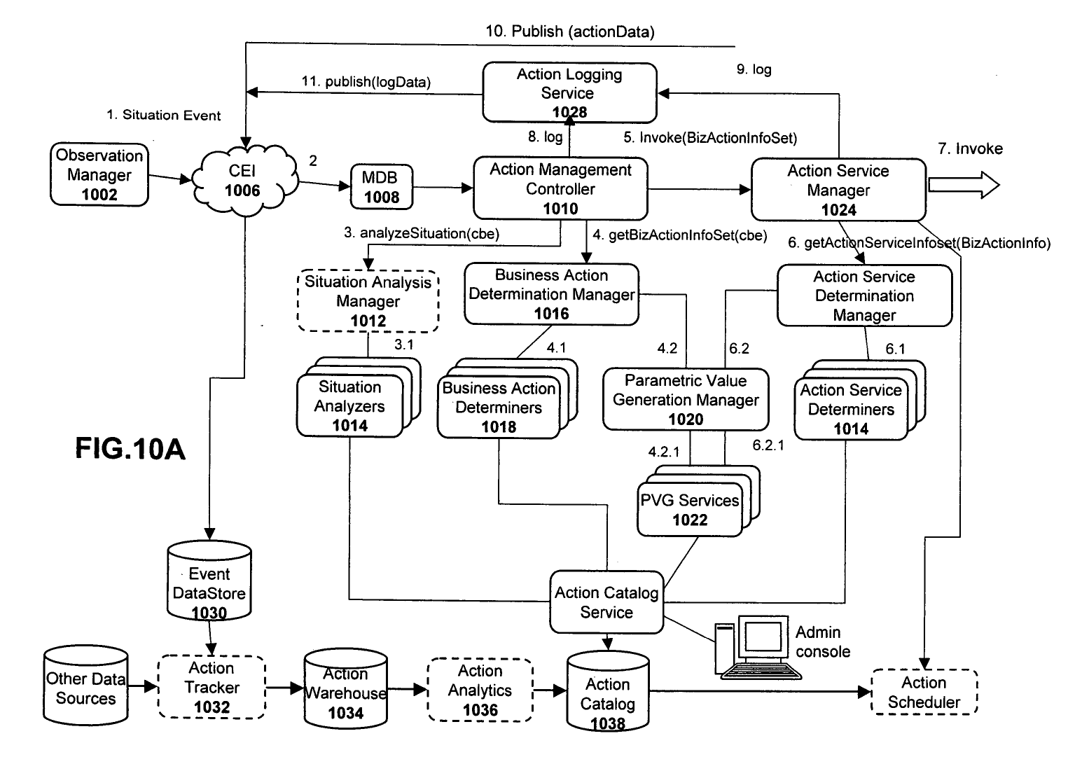

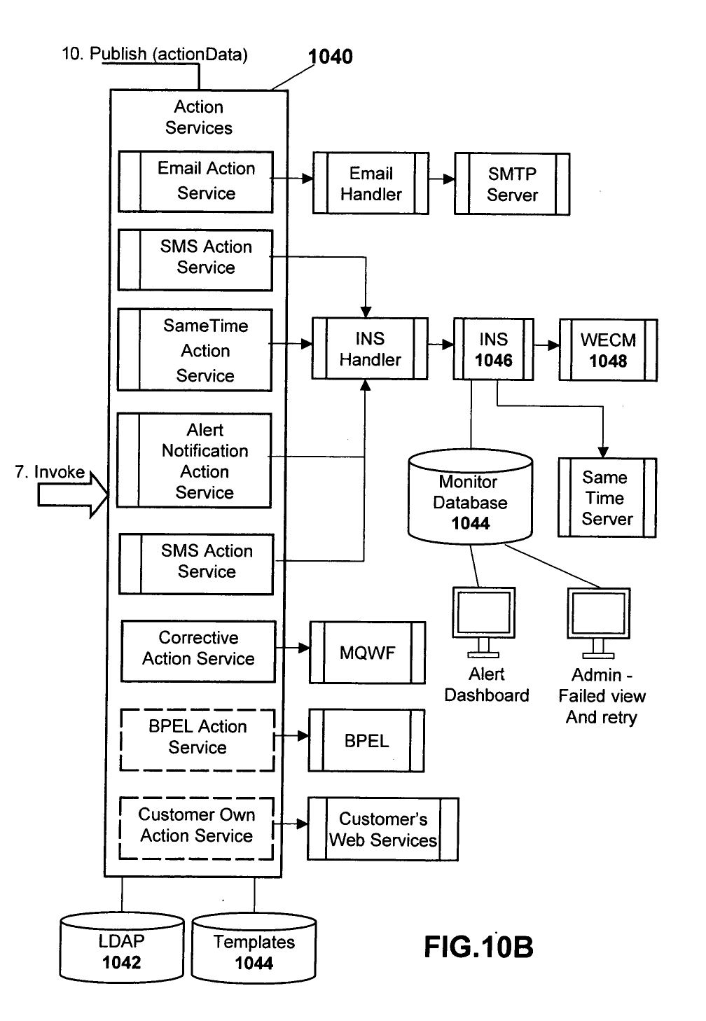

FIGS. 10A-10B illustrate an architecture (e.g., system architecture) 1000 according to an exemplary aspect of the present invention. The architecture 1000 in this exemplary aspect is similar to the aspects of the present invention described above with respect to FIGS. 2 and 6. Thus, the discussion above with respect to FIGS. 2 and 6 is incorporated herein by reference.

As illustrated in FIG. 10A, in this architecture, the Observation Manager 1002 detects business situations and sends the situations to the Adaptive Action Manager (AAM) via the event bus (e.g., Common Event Infrastructure (CEI)) 1006. The Message Driven Bean (MDB) 1008 catches situation events and can forward them to AAM.

Further, Action Management Controller 1010 is a component that coordinates the control and data flows within AAM. Situation Analysis Manager 1012 analyzes the received situation events by calling embedded Situation Analyzers 1014 to decide whether this received events can be or worth to be processed. If yes, the Business Action Determination Manager 1016 will decide what business actions to be taken via Business Action Determiners 1018 and what parametric values to be used via the Parametric Value Generation (PVG) Manager 1020(and the embedded PVG services 1022).

Once business actions are determined, the Action Service Manager 1024 will determine what physical action services to be invoked via embedded Action Service Determiners 1026. The aforementioned decision making process and invocation process are recorded through the Action Logging Service 1028 and some of them are passed to other components through the event bus. Event Data Store 1030 keeps such records in the persistent storage.

Action tracker 1032 tracks the action performed to the target business processes and systems and keeps the observation into the Action Warehouse 1034. Action Analytics 1036 are analytical components that will measure the performed actions and analyze their effectiveness. If an improvement is possible, the plan of such improvement will be realized into the Action Catalog 1038 that contains all the decision making scheme for AAM.

FIG. 10B illustrates an example of action services 1040 that may be invoked (e.g., by the AAM. The action services 1040 may access an Lightweight Directory Access Protocol (LDAP) directory 1042 and templates 1044. Further, the action servics 1040 may include a system management server (SMS) action service, and may utilize an integrated netfinity server (INS) 1046 and a Websphere Everyplace Connections Manager (WECM) 1048.

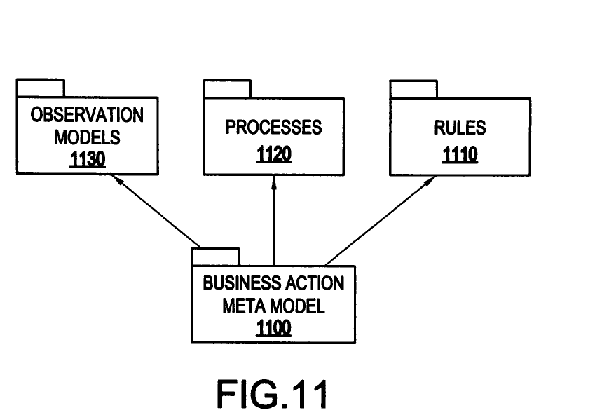

FIG. 11 illustrates a business action meta model 1100 according to the exemplary aspects of the present invention. As illustrated in FIG. 11, the business action model 1100 may be used in the present invention to provide rules 1110, processes 1120, and observation models 1130.

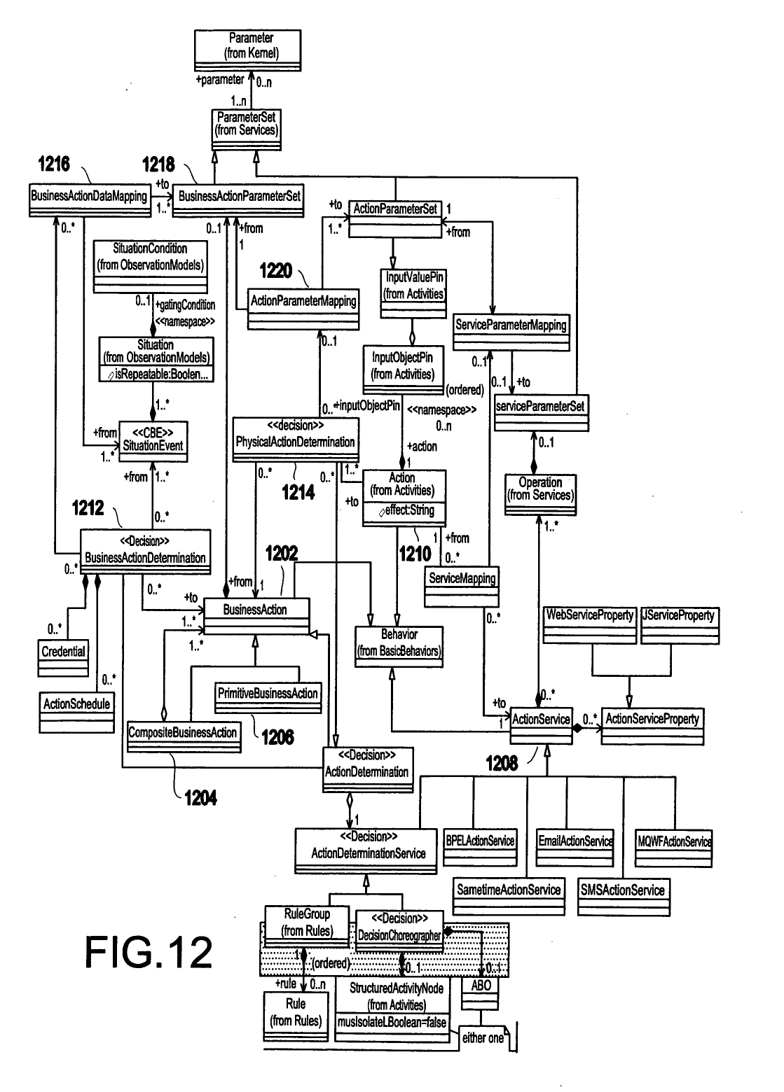

Further, FIG. 12 provides a detailed illustration of a business action metal model 1100 according to the exemplary aspects of the present invention.

FIG. 12 is a diagram which illustrates the UML-based (Unified Modeling Language-based) metamodel for Adaptive Action Manager. Business Action 1202 is a central concept captured in this metamodel where PrimitiveBusinessAction 1204 and CompositeBusinessAction 1206 are both defined as well.

Further, Action Service metaclass 1208 represents the implementation of physical action services that may be invoked by AAM. On the other hand, the Action metaclass 1210 represents the logical interfaces of such implementation. BusinessActionDeterminer 1212 (PhysicalActionDeterminer 1214) decides what Business Action (ActionService) to be taken.

BusinessActionDataMapping 1216 mediates the data between received situation events and business action parameters 1218. Similarly, the ActionDataMapping (e.g., action parameter mapping 1220) mediates the data between Business Action parameters and Action Service parameters.

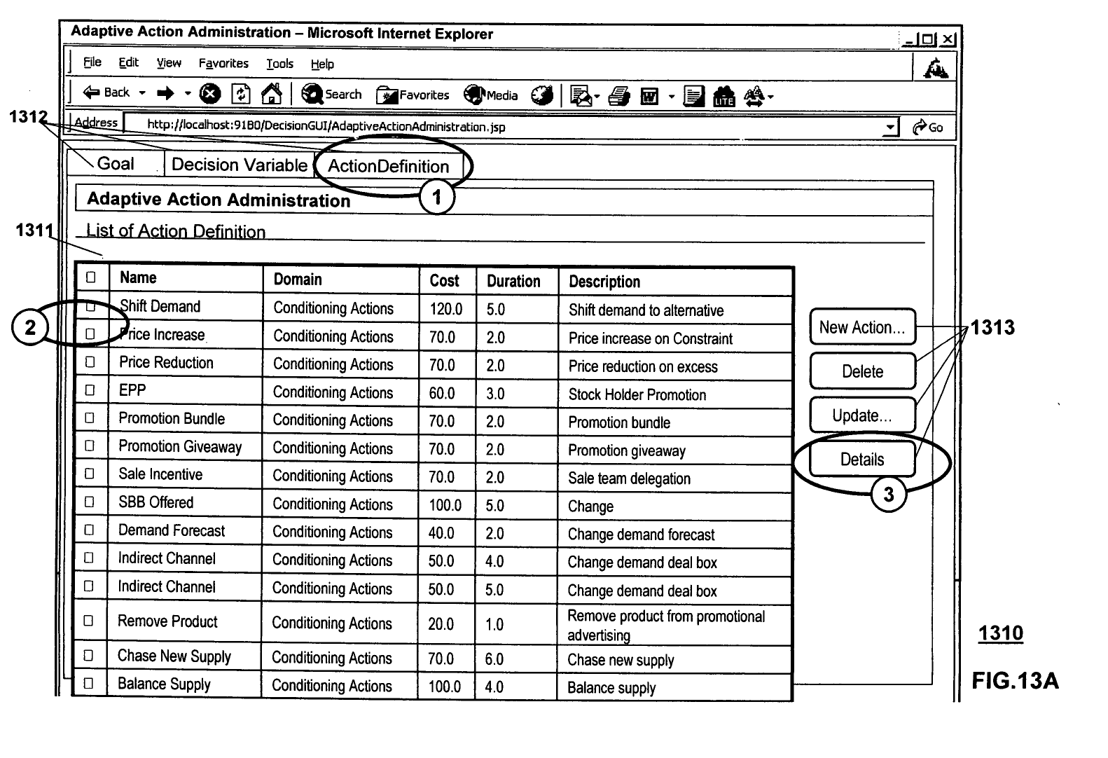

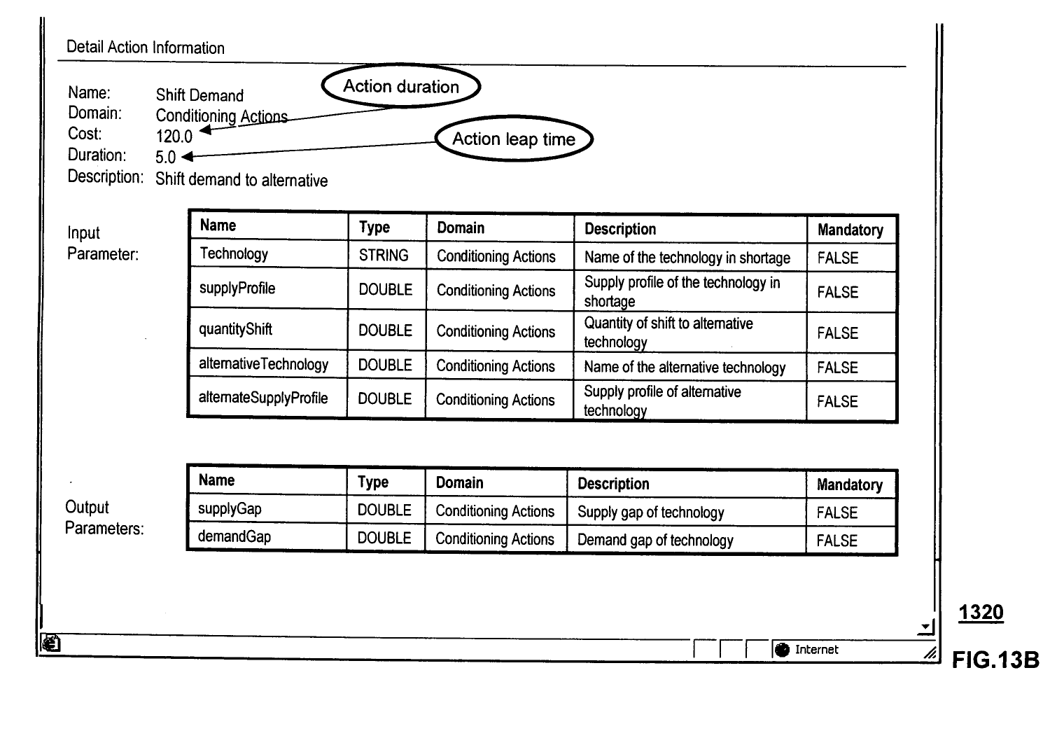

FIGS. 13A-13B illustrate exemplary screenshots 1310, 1320 (e.g., views displayed on a display screen of a graphical user interface (GUI)) which may be included in the exemplary aspects of the present invention. Specifically, these screen shots may be generated by PCD Dashboard software which may be used to implement the exemplary aspects of the present invention.

For example, the screenshot 1310 illustrated in FIG. 13A may be used to define actions. The screenshot 1310 may include, for example, boxes 1312 for selecting (e.g., using a mouse or keyboard) from among a goal, decision variable, and action definition. The screenshot 1320 may also include a list of action definitions 1311 which includes action name, domain, cost, duration and description. In addition, the screenshot 1310 may include boxes 1313 for selecting a new action, delete an action, update an action or details of an action.

The screenshot 1320 illustrated in FIG. 13B may be used to view a detailed action definition. For example, clicking on the “details” box 1313 in screenshot 1310 may cause the screenshot 1320 to be generated on the GUI display. The screenshot 1320 may include the action name, domain, cost (e.g., action duration), duration (e.g., action leap time) and description. The screenshot 1320 may also include the input parameters and output parameters for an action.

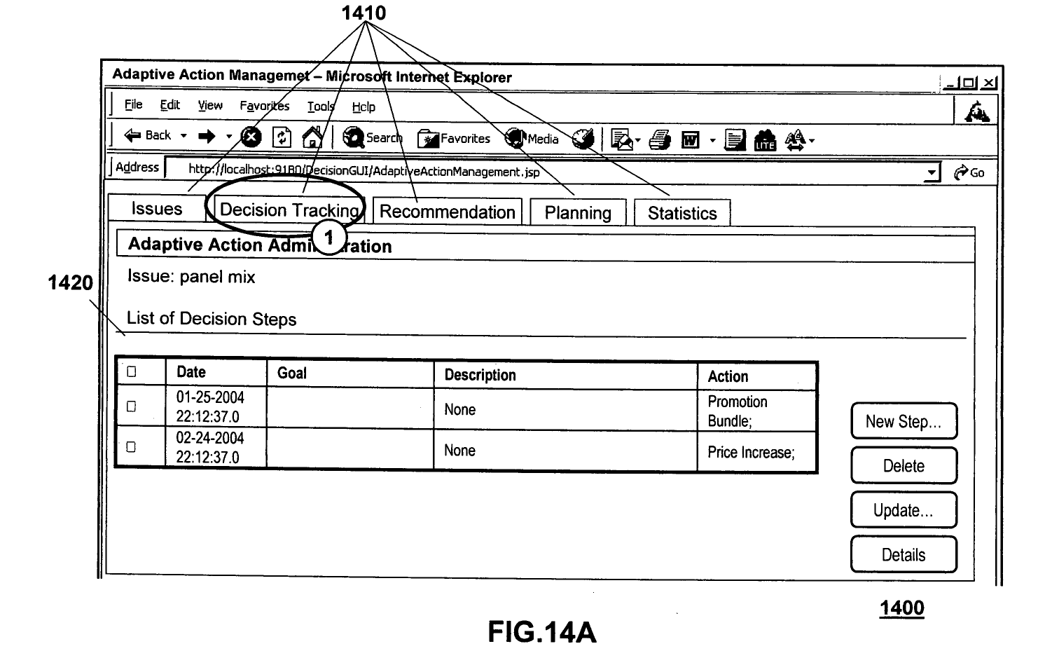

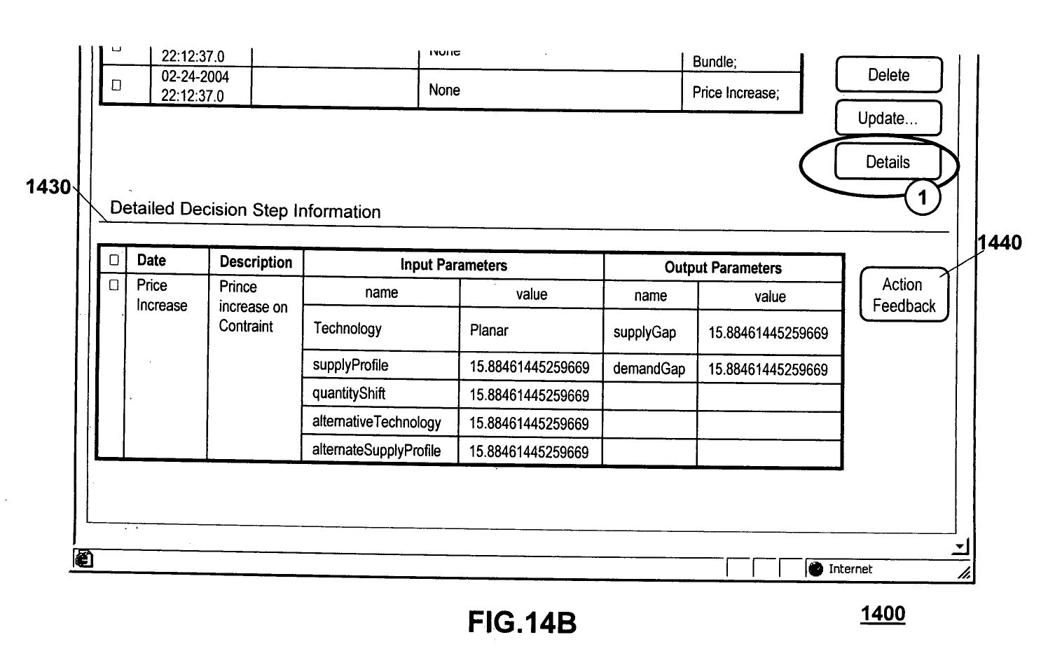

FIGS. 14A-14B illustrate a top and bottom portion, respectively, of a screenshot 1400 which may be included in the exemplary aspects of the present invention. Specifically, as with screenshots 1310 and 1320, this screenshot 1400 may be generated by PCD Dashboard software which may be used to implement the exemplary aspects of the present invention.

As illustrated in FIG. 14A, the screenshot 1400 may be used for tracking decisions (e.g., business actions) in the exemplary aspects of the present invention. The screenshot 1400 may include boxes 1410 for selecting issues, decision tracking, recommendation, planning and statistics. Thus, by selecting the “issues” box 1410 the screenshot 1400 may be generated.

Further, the screenshot 1400 may also include a list 1420 of decision steps.

Further, as illustrated in FIG. 14B, the screenshot 1400 may an area 1430 which provides detailed decision step information. The screenshot 1440 may also include a box 1440 which may be selected to view action feedback.

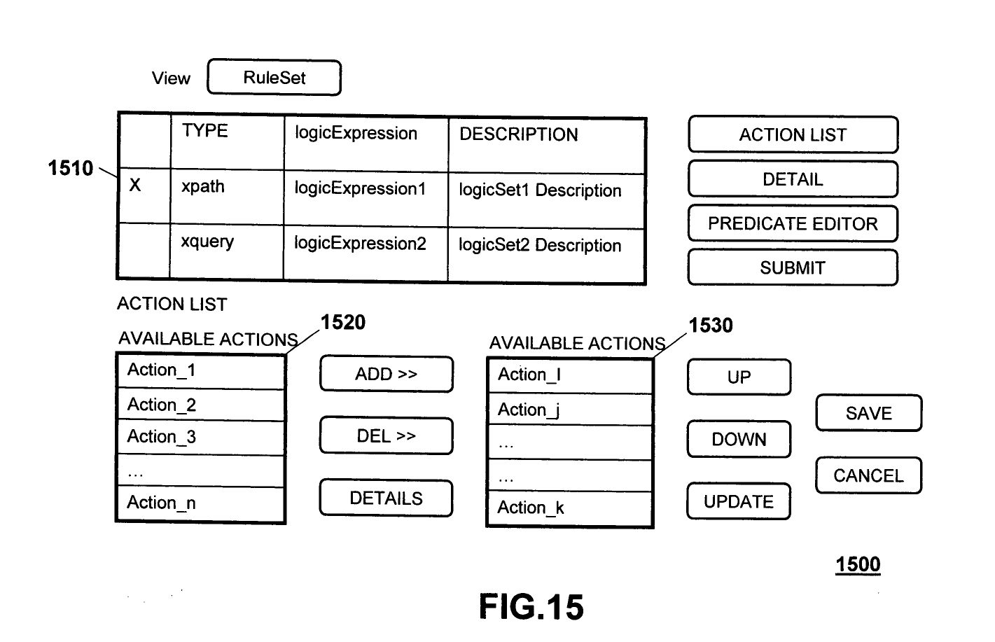

FIG. 15 illustrates another screenshot 1500 which may be included in the exemplary aspects of the present invention. The screenshot 1500 provides an example of how business actions may be determined using the exemplary aspects of the present invention. Specifically, the screenshot 1500 may include an area 1510 which provides for an action, a type, logic expression and description. The screenshot 1500 may also include an action list including available actions 1520 and selected actions 1530. The screen shot 1500 may also include various boxes for navigating between the area 1510, available actions 1520 and selected actions 1530.

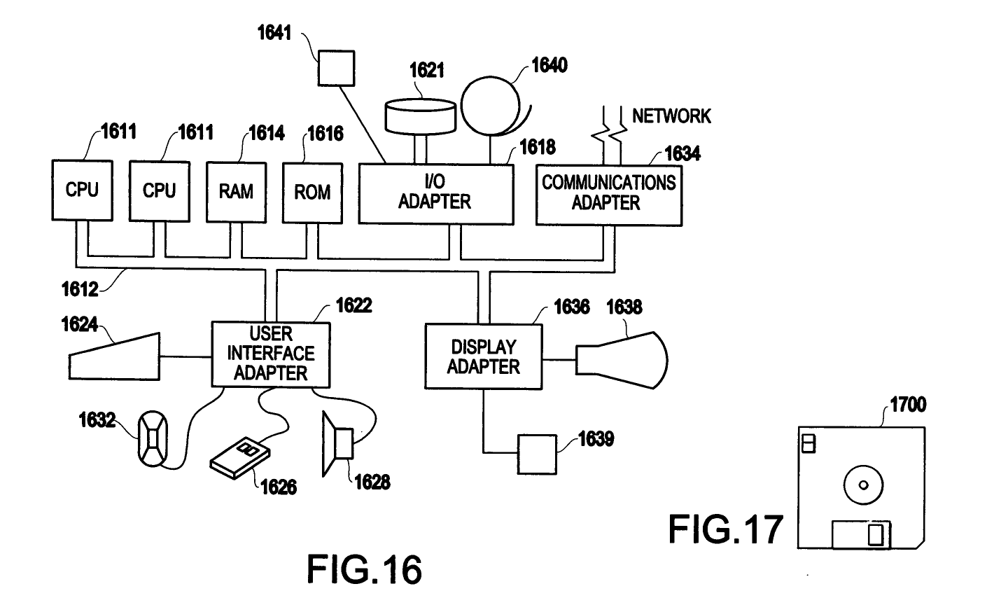

Referring now to FIG. 16, system 1600 illustrates a typical hardware configuration which may be used for implementing the inventive system and method for identifying a word correspondence. The configuration has preferably at least one processor or central processing unit (CPU) 1611. The CPUs 1611 are interconnected via a system bus 1612 to a random access memory (RAM) 1614, read-only memory (ROM) 1616, input/output (I/O) adapter 1618 (for connecting peripheral devices such as disk units 1621 and tape drives 1640 to the bus 1612), user interface adapter 1622 (for connecting a keyboard 1624, mouse 1626, speaker 1628, microphone 1632, and/or other user interface device to the bus 1612), a communication adapter 1634 for connecting an information handling system to a data processing network, the Internet, and Intranet, a personal area network (PAN), etc., and a display adapter 1636 for connecting the bus 1612 to a display device 1638 and/or printer 1639. Further, an automated reader/scanner 1641 may be included. Such readers/scanners are commercially available from many sources.

In addition to the system described above, a different aspect of the invention includes a computer-implemented method for performing the above method. As an example, this method may be implemented in the particular environment discussed above.

Such a method may be implemented, for example, by operating a computer, as embodied by a digital data processing apparatus, to execute a sequence of machine-readable instructions.

These instructions may reside in various types of signal-bearing media.

Thus, this aspect of the present invention is directed to a programmed product, including signal-bearing media tangibly embodying a program of machine-readable instructions executable by a digital data processor to perform the above method.

Such a method may be implemented, for example, by operating the CPU 1611 to execute a sequence of machine-readable instructions. These instructions may reside in various types of signal bearing media.

Thus, this aspect of the present invention is directed to a programmed product, including signal-bearing media tangibly embodying a program of machine-readable instructions executable by a digital data processor incorporating the CPU 1611 and hardware above, to perform the method of the invention.

This signal-bearing media may include, for example, a RAM contained within the CPU 1611, as represented by the fast-access storage for example. Alternatively, the instructions may be contained in another signal-bearing media, such as a magnetic data storage diskette 1700 (FIG. 17), directly or indirectly accessible by the CPU 1611.

Whether contained in the computer server/CPU 1611, or elsewhere, the instructions may be stored on a variety of machine-readable data storage media, such as DASD storage (e.g, a conventional “hard drive” or a RAID array), magnetic tape, electronic read-only memory (e.g., ROM, EPROM, or EEPROM), an optical storage device (e.g., CD-ROM, WORM, DVD, digital optical tape, etc.), paper “punch” cards, or other suitable signal-bearing media including transmission media such as digital and analog and communication links and wireless. In an illustrative embodiment of the invention, the machine-readable instructions may comprise software object code, complied from a language such as “C” etc.

With its unique and novel features, the present invention provides an adaptive action management mechanism in which the business solution can respond to situation through dynamic action determination, the business can adapt external data sources to invoke actions, and/or the business solutions can select the best implementation for a desired business action.

While the invention has been described in terms of one or more exemplary embodiments, those skilled in the art will recognize that the invention can be practiced with modification within the spirit and scope of the appended claims. Specifically, one of ordinary skill in the art will understand that the drawings herein are meant to be illustrative, and the design of the inventive assembly is not limited to that disclosed herein but may be modified within the spirit and scope of the present invention.

Further, Applicant's intent is to encompass the equivalents of all claim elements, and no amendment to any claim the present application should be construed as a disclaimer of any interest in or right to an equivalent of any element or feature of the amended claim.

1. A method of adaptive action management for business solutions, comprising:
detecting a business situation;
adaptively deciding an action for a detected business situation using information from a knowledge base; and
invoking an action service for implementing said action.

2. The method of claim 1, wherein said detecting said business situation comprises monitoring business solutions and detecting business situations and exceptions according to situation rules.

3. The method of claim 1, wherein said detecting said business situation comprises using a rules engine which correlates a business event emitted from a business solution and detects an event pattern to decide whether said business situation occurred.

4. The method of claim 1, wherein said detecting said business situation comprises deriving said business situation from a status of a business process with a predefined exceptional state.

5. The method of claim 1, wherein said adaptively deciding said action comprises:
processing incoming business situations; and
choosing a business action determination mechanism.

6. The method of claim 1, wherein said adaptively deciding said action further comprises:
deciding a business action to be taken;
mediating necessary data for the decided business action; and
selecting a best action service for said decided business action.

7. The method of claim 6, wherein said adaptively deciding said action further comprises:
invoking a selected action service;
executing the invoked action service; and
tracking a result of said executing said invoked action service.

8. The method of claim 1, wherein said information comprises at least one of decision rules for choosing action determination services, logics of determining business actions, data mediation logics for parametric data of business actions, bindings and criteria for selecting an action service for a given business action, and a metadata of action services.

9. The method of claim 1, wherein said action service triggers an associated implementation module.

10. The method of claim 1, wherein said action service comprises at least one of a Java component, a World Wide Web (WWW) service, a workflow, and a rule.

11. A system for adaptive action management for business solutions, comprising:
a business situation detector which detects a business situation; and
an adaptive action manager which adaptively decides an action for a detected business situation, and invokes an action service for implementing said action.

12. The system of claim 11, further comprising:
a knowledge base which is accessible by said adaptive action manager, and stores information, said adaptive action manager deciding said action based on said information.

13. The system of claim 11, further comprising:
an event processor which comprises said business situation detector and at least one of a correlator and a metric caculator.

14. The system of claim 11, wherein said adaptive action manager comprises:
an action mediation manager;
a decision-making processor which is consulted by said action mediation manager and returns business actions to said action mediation manager; and
an action service manager which receives an invocation of an action service from said action mediation manager and outputs a directive to a target business solution.

15. The system of claim 14, wherein said action mediation manager comprises:
an action determination service which consults with said decision-making processor;
a data mediator which maps data sources to action parameters;
an action planner which generates an invocation plan for target actions; and
an action service selector which selects said action service.

16. The system of claim 14, wherein said action service manager comprises an action tracker which tracks an action service invoked by said adaptive action manager, and
wherein said adaptive action manager further comprises an action exception handler which resolves an exception received from said action tracker.

17. The system of claim 14, wherein said business solution comprises one of a workflow management system (WFMS), enterprise resource planning (ERP) system, a legacy system, a database, and an external source.

18. The system of claim 11, wherein said adaptive action manager comprises:
a metal level control layer comprising an action determiner determiner (ADD), a performance profile, and a decision tree;
a control layer comprising an action determiner (AD), a scheduler, and a planner; and
an execution layer comprising a monitor and an effector, an action effect being fedback from said execution layer to said metal level control layer.

19. A programmable storage medium tangibly embodying a program of machine-readable instructions executable by a digital processing apparatus to perform a method of adaptive action management for business solutions, said method comprising:
detecting a business situation;
adaptively deciding an action for a detected business situation using information from a knowledge base; and
invoking an action service for implementing said action.

20. The method of claim 1, further comprising:
deploying computing infrastructure in which computer-readable code is integrated into a computing system, such that said code and said computing system combine to perform said method.
